(19) United States
(12) Patent Application Publication
(10) Pub. No.: US 2018/0191289 A1
(43) Pub. Date: Jul. 5, 2018

(54) BRACKET FOR SECURING SOLAR PANELS

(71) Applicant: Guohao Zhu, Haining City (CN)

(72) Inventor: Guohao Zhu, Haining City (CN)

(73) Assignee: Guohao Zhu, Haining City (CN)

(21) Appl. No.: 15/405,779

(22) Filed: Jan. 13, 2017

(30) Foreign Application Priority Data
Jan. 4, 2017 (CN) 201710003701.4

(51) Int. Cl. H02S 20/23; F16M 13/02

(52) U.S. Cl. CPC H02S 20/23; F16M 13/02

(57) ABSTRACT

The present invention provides a mounting bracket for attaching solar panels to a roof top. Also provided is a method of installing solar panels on a roof top with the mounting bracket disclosed herein.

### FIELD OF THE INVENTION

The present invention relates to a mounting bracket and a method of installing solar panels.

### BACKGROUND OF THE INVENTION

Solar power has long been viewed as an important alternative energy source. To this end, substantial efforts and investments have been made to develop and improve upon solar energy collection technology. Of particular interest are residential-, industrial- and commercial-type applications in which relatively significant amounts of solar energy can be collected and utilized in supplementing or satisfying power needs. One way of implementing solar energy collection technology is by assembling an array of multiple solar modules.

One type of solar energy system is a solar photovoltaic system. Solar photovoltaic systems (“photovoltaic systems”) can employ solar panels made of silicon or other materials (e.g., III-V cells such as GaAs) to convert sunlight into electricity. Photovoltaic systems typically include a plurality of photovoltaic (PV) modules (or “solar tiles”) interconnected with wiring to one or more appropriate electrical components (e.g., switches, inverters, junction boxes, etc.).

Most PV applications entail placing an array of solar modules at the installation site in a location where sunlight is readily present. This is especially true for residential, commercial or industrial applications in which multiple solar modules are desirable for generating substantial amounts of energy, with the rooftop of the structure providing a convenient surface at which the solar modules can be placed. it can be important to ensure that the array of solar modules or panels is reliably and stably anchored to the roof, whether the roof is an angled or flat roof. Moreover, it can be important to ensure that a user can easily, effectively, and rapidly mount one or more solar module(s) or panels to the roof.

### SUMMARY OF THE INVENTION

An aspect of the invention provides a mounting bracket for attaching one or more solar panels to a roof top. The mounting bracket includes a top plate and a pair of parallel walls, wherein the parallel walls extend perpendicular to the top plate and are connected to opposite edges of the top plate. A cutout extends from the top plate downward into the parallel walls, the cutout having two opposing side edges and a bottom edge in each of the walls. The bottom edge of the cutout is parallel to the top plate and extends beyond both side edges of the cutout to form a first and second guide channels on each side edge, and each of the first and second guide channels is configured to engage a L-shaped portion of a frame of a solar panel.

In some embodiments, the top plate includes an attachment means which can be protrusions for securing the solar panel onto the mounting bracket once the L-shaped portion of the frame of the solar panel is fully engaged with the first or second guide channel. Additionally, at least one of the walls of the mounting bracket has an adjustment means for engaging with a mounting base and adjusting position of the mounting bracket relative to the mounting base.

In some embodiments, one of the walls is perpendicularly connected to a bottom plate, the bottom plate extending outward and further connecting perpendicularly to a lower wall. The bottom plate can include an attachment means for securing the solar panel onto the mounting bracket.

In some embodiments, each of the top walls extends downward and is perpendicularly connected to a respective bottom plate, the bottom plate extending outward from the bottom edges of the respective walls and further connecting perpendicularly to a respective bottom wall, wherein the bottom wall is parallel to the top walls and extends below a bottom surface of the respective bottom plate. At least one of the bottom plates includes an attachment means for securing the solar panel onto the mounting bracket.

In some embodiments, the mounting bracket further includes a second pair of top walls and a bottom plate perpendicularly disposed between the first pair and the second pair of top walls. A first inner wall of the first pair of top walls and a second inner wall of the second pair of top walls are connected to opposite edges of the bottom plate, and the second pair of walls defines a second cutout substantially mirror the cutout in the first pair of walls. Alternatively speaking, the second cutout is symmetrical to the respective first cutout across a virtual plane between the first pair and second pair of walls. The bracket also includes an adjustment means for engaging with a mounting base and adjusting position of the mounting bracket relative to the mounting base.

In some embodiments, the mounting bracket includes a first pair of parallel walls, second pair of parallel walls, a bottom plate. The first pair of parallel walls has a first inner wall and a first outer wall, wherein the a first inner wall and the first outer wall at their respective top edges are connected to opposite edges of a first top plate perpendicularly disposed between the first pair of walls. The second pair of parallel walls has a second inner wall and a second outer wall, wherein the second inner wall and the second outer wall at their respective top edges are connected to opposite edges of a second top plate perpendicularly disposed between the second pair of walls. The bottom plate is perpendicularly disposed between the first and second inner walls and connected to the respective bottom edges of the first and second inner walls, wherein the inner and outer walls each includes a cutout from the respective top plates for receiving a frame of one or more solar panels, the cutout having two opposing side edges and a bottom edge above the bottom plate, further wherein the bottom edge of the cutout is parallel to the bottom plate and extends beyond both side edges of the cutout to form a first and second guide channels on each side edge, each of the first and second guide channels is configured to engage a L-shaped portion of a frame of a solar panel. The bracket can include an attachment means for securing the solar panel onto the mounting bracket once the L-shaped portion of the frame of the solar panel is fully engaged with the first or second guide channel. In some embodiments, the attachment means includes at least a first resilient protrusion protruding from the bottom plate upwards at an angle with respect to a top surface of the bottom plate, wherein the protrusion is oriented parallel to the inner side plate and pointing away from a virtual plane across the middle of the cut-outs. In some embodiments, the attachment means also includes a second resilient protrusion protruding from the bottom plate upwards at an angle with respect to the surface of the mounting plate and oriented parallel to the virtual plane across the middle of the cut-outs on both sides of the bottom plate, wherein the second resilient protrusion has a serrated top edge configured to touch a bottom surface of the frame of the solar panel when the L-shaped portion of the frame of the solar panel is fully engaged with the first or second guide channel so that the solar panel is prevented from lateral movement perpendicular to the guide channel.

Another aspect of the invention provides an apparatus including the mounting brackets described herein. The apparatus can further include a mounting base to secure the bracket to the rooftop. Also provided is a method of installing one or more solar panels on a roof top.

### BRIEF DESCRIPTION OF THE DRAWINGS

FIG. 1 illustrates a mounting assembly 10 including an anchor plate 100, a mounting bracket 200 and a mounting base 200.

FIG. 2 illustrates an anchor plate 100 including reinforcement bars 102, water guard 103 and an anchor point 104.

FIG. 3 illustrates a mounting bracket 200 including mounting plate 202, ridge portions 3, outer side plates 4, cutout 205, first guide channels 206 and 207, second guide channels 208 and 209, first resilient protrusion 211, second resilient protrusion 212, reinforcement bar 213, reinforcement bar 214, and inner side plate 220.

FIG. 4 illustrates a top view of the mounting bracket 200.

FIG. 5 illustrates a side view of the mounting bracket 200.

FIG. 6 illustrates the engagement of L-shaped arm 401 into guide channel 206 (207).

FIG. 7 illustrates a side view of the first protrusion 211 and the second protrusion 212 for securing the L-shaped arm 401 in the guide channel 206 (207).

FIG. 8 illustrates a side view of the first protrusion 211 and the second protrusion 212 in contact with the L-shaped arm 401.

FIG. 9 illustrates a single pair of first resilient protrusions 211 in mounting bracket 200.

FIG. 10 illustrates mounting bracket 200 including supporting arms 223, locking teeth 224 and locking hole 225.

FIG. 11 illustrates mounting bracket 200 including supporting arms 223 and locking teeth 224.

FIG. 12 illustrates mounting bracket 200 engaging with mounting base 300.

FIG. 13 illustrates a mounting base having adjustment channel 314.

FIG. 14 illustrates a perspective view of the mounting bracket 600.

FIG. 15 illustrates a side view of the mounting bracket 600.

FIG. 16 illustrates a top view of the mounting bracket 600.

FIG. 17 illustrates a perspective view of the mounting bracket 700.

FIG. 18 illustrates a front view of the mounting bracket 700.

FIG. 19 illustrates a perspective view of the mounting bracket 800.

FIG. 20 illustrates a side view of the mounting bracket 800.

FIG. 21 illustrates a front view of the mounting bracket 800.

FIG. 22 illustrates a perspective view of the mounting bracket 900.

FIG. 23 illustrates a front view of the mounting bracket 900.

FIG. 24 illustrates a perspective view of the mounting bracket 1200.

FIG. 25 illustrates a perspective view of the mounting bracket 1000.

FIG. 26 illustrates a front view of the mounting bracket 1000.

FIG. 27 illustrates a perspective view of the mounting bracket 1100.

FIG. 28 illustrates a perspective view of the attachment of the mounting bracket 1100 to a mounting base.

FIG. 29 illustrates a front view of the attachment of the mounting bracket 1100 to a mounting base.

FIG. 30 illustrate anchor plate 100 installed on a roof top.

FIG. 31 illustrates the process of setting up the mounting bracket 200 on the mounting base 300.

FIG. 32 illustrates the step of placing a front bottom frame 402 of the solar panel 400 into the cutout of the mounting bracket in first row so that the L-shaped arm 401 of the front bottom frame 402 is aligned with the first guide channel.

FIG. 33 illustrates a step of installing the solar panel by sliding the front bottom frame 402 of the solar panel 400.

FIG. 34 illustrates a step of installing the solar panel by sliding the mounting bracket downward to engage the L-shaped arm 401 of the rear bottom frame 402.

FIG. 35 illustrates two mounting brackets each marked as 1300, which if connected to each other form a mounting bracket similar to 600.

FIG. 36 illustrates two mounting brackets each marked as 1400, which if connected to each other form a mounting bracket similar to 700.

FIG. 37 illustrates two mounting brackets each marked as 1500, which if connected to each other form a mounting bracket similar to 800.

FIG. 38 illustrates two mounting brackets each marked as 1600, which if connected to each other form a mounting bracket similar to 900.

### DETAILED DESCRIPTION OF THE INVENTION

Various embodiments of the invention disclose a bracket for mounting a photovoltaic system. The mounting bracket is structurally and functionally advantageous over conventional devices in terms of simplified and improved components and enhanced stability. The mounting bracket also allows for fast and convenient adjustment during the mounting process of solar panels. The mounting bracket can be manufactured from the design of a single metal piece which further lowers the production cost with improved durability and installation stability.

While the inventions disclosed herein are often described in the context of photovoltaic panels, arrays and modules, these inventions can be used in other contexts as well, such as concentrated PV systems, thermal solar systems, etc.

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

In at least a first embodiment, the present invention provides a mounting bracket having a first pair of walls, a second pair of walls, and a bottom plate perpendicularly disposed between the two pairs of walls. The top portion of the mounting bracket serves to engage the solar panels. The bottom portion can be secured to a mounting base or a rooftop.

The first pair of parallel walls have a first inner wall and a first outer wall, wherein the a first inner wall and the first outer wall at their respective top edges are connected to opposite edges of a first top plate perpendicularly disposed between the first pair of walls.

The second pair of parallel walls have a second inner wall and a second outer wall, wherein the second inner wall and the second outer wall at their respective top edges are connected to opposite edges of a second top plate perpendicularly disposed between the second pair of walls.

The bottom plate is perpendicularly disposed between the first and second inner walls and connected to the respective bottom edges of the first and second inner walls. The first and second outer walls are generally longer than the inner walls and extend below a bottom surface of the bottom plate.

The inner and outer walls each comprise a cutout from the respective top plates for receiving a frame of one or more solar panels, wherein the cutout has two opposing side edges and a bottom edge above the bottom plate, further wherein the bottom edge of the cutout is parallel to the bottom plate and extends beyond both side edges of the cutout to form a first and second guide channels on each side edge, each of the first and second guide channels is configured to engage a L-shaped portion of a frame of a solar panel.

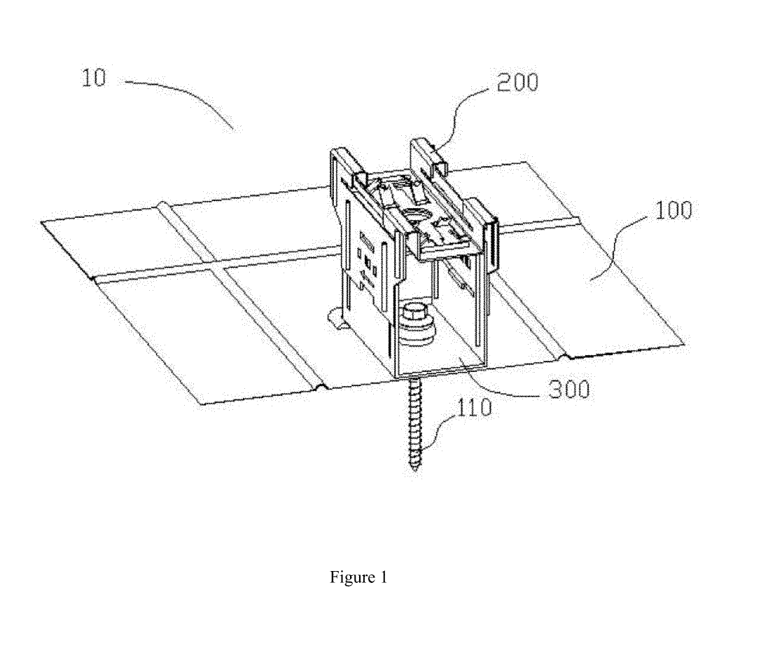

Referring to FIG. 1, an exemplary embodiment of a mounting assembly 10 includes an anchor plate 100, a mounting bracket 200 and a mounting base 200. The assembly 10 is secured to a structure such as rooftop via a screw 110.

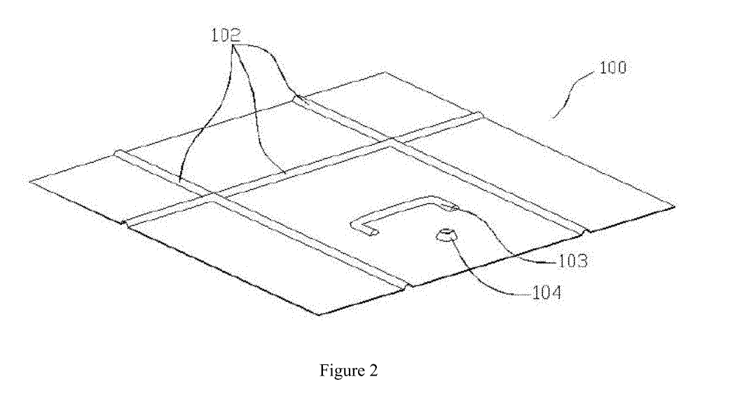

Referring to FIG. 2, an exemplary anchor plate 100 includes reinforcement bars 102, water guard 103 and an anchor point 104.

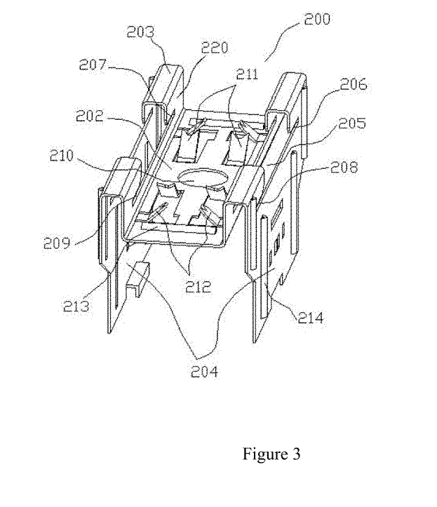

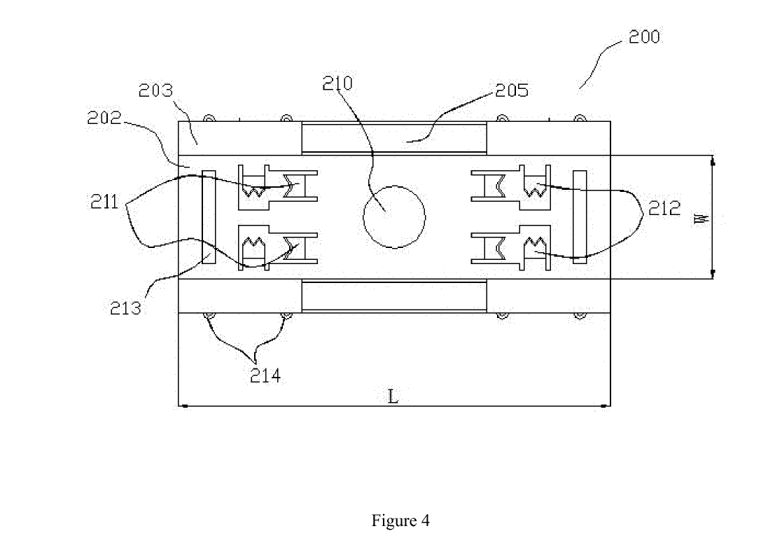

Referring to FIG. 3-4, an exemplary mounting bracket 200 includes bottom plate 202, top plates 3 on both sides of the bracket 200, top plates 203, first and second outer walls 204, first and second inner walls 220, cutout 205 in the inner and outer walls, first guide channels 206 and 207, second guide channels 208 and 209, first resilient protrusion 211, second resilient protrusion 212, reinforcement bar 213, and reinforcement bar 214.

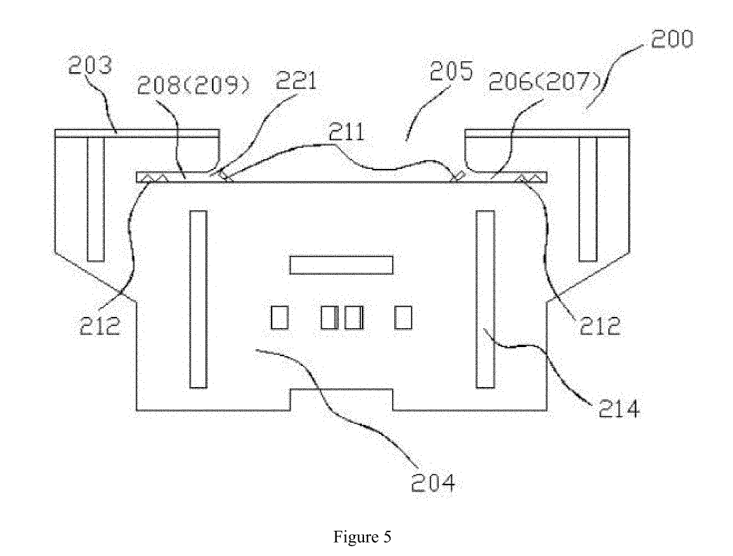

Referring to FIG. 5, each of the inner walls and outer walls 203 and 204 includes a cut-out extending from the respective top plates towards the bottom plate. A virtual plane across the parallel lower ends of the cut-outs is adjacent or below the first resilient protrusion 211 and/or second resilient protrusion 212. The cut-outs then extend laterally in opposite directions to form the first guide channel 206 and 207 and the second guide channel 208 and 209. Preferably, the entry point 221 is wider than the inner end of the guide channel. In some embodiments, the entry point 221 has a convex surface so that the arm of the solar panel can slide in easily.

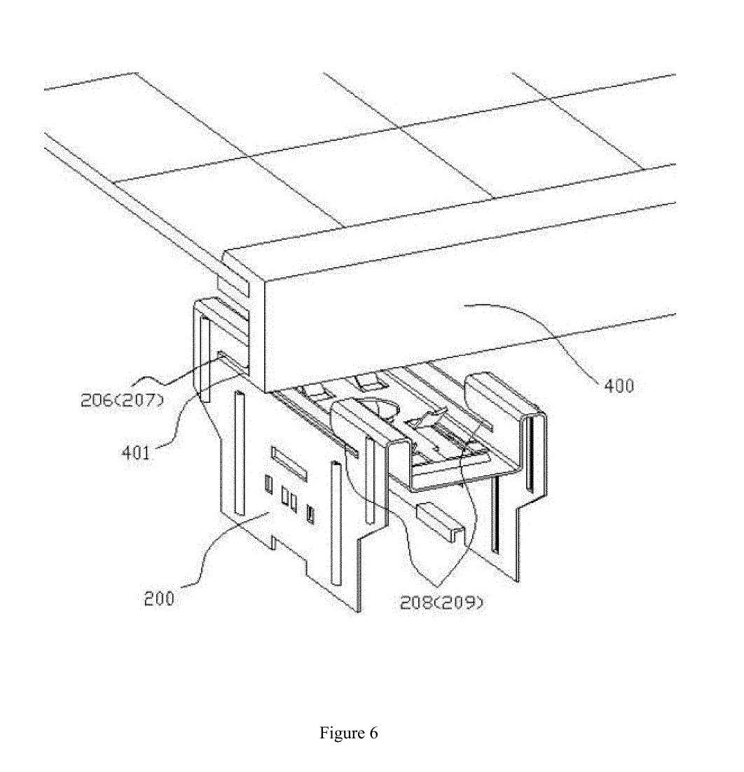

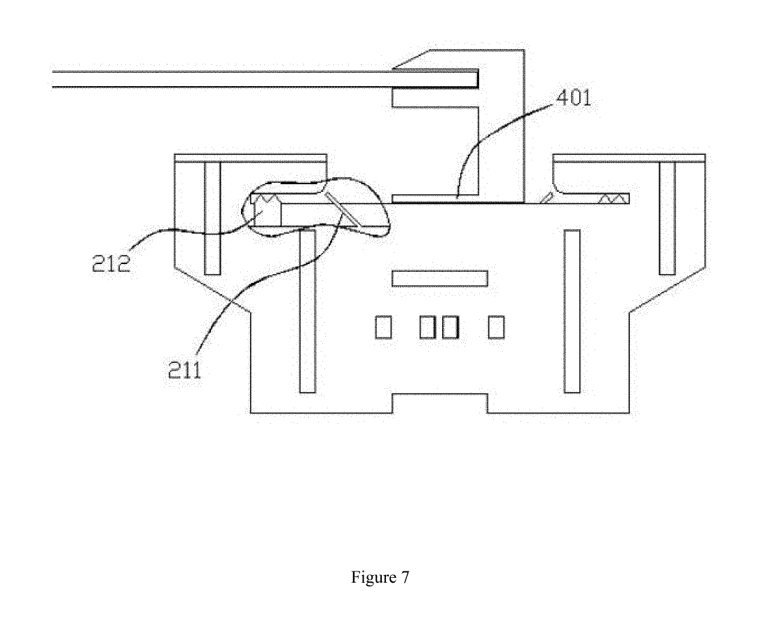

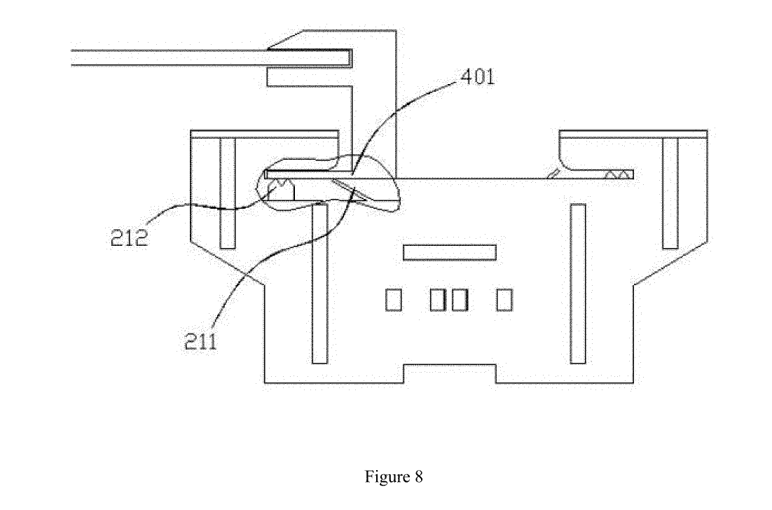

The bottom plate 202 in FIG. 3 includes first resilient protrusions 211 and second resilient protrusions 212. The first resilient protrusions 211 point away at an angle from a virtual plane across the middle of the cutouts in the walls. As is illustrated in FIGS. 6-8, the first resilient protrusion 211 can have a serrated top edge configured to touch a bottom surface of the frame of the solar panel when the L-shaped portion of the frame of the solar panel is fully engaged with the first or second guide channel so that the solar panel is prevented from longitudinal movement along the guide channel. Similar to the first resilient protrusions 211, the second resilient protrusion 212 can similarly have a serrated top edge configured to touch a bottom surface of the frame of the solar panel. However, the second resilient protrusions 212 are oriented parallel to the virtual plane across the middle of the cut-outs in the walls. Therefore, when the L-shaped portion of the frame of the solar panel is fully engaged with the first or second guide channel, the solar panel is prevented from lateral movement perpendicular to the guide channel.

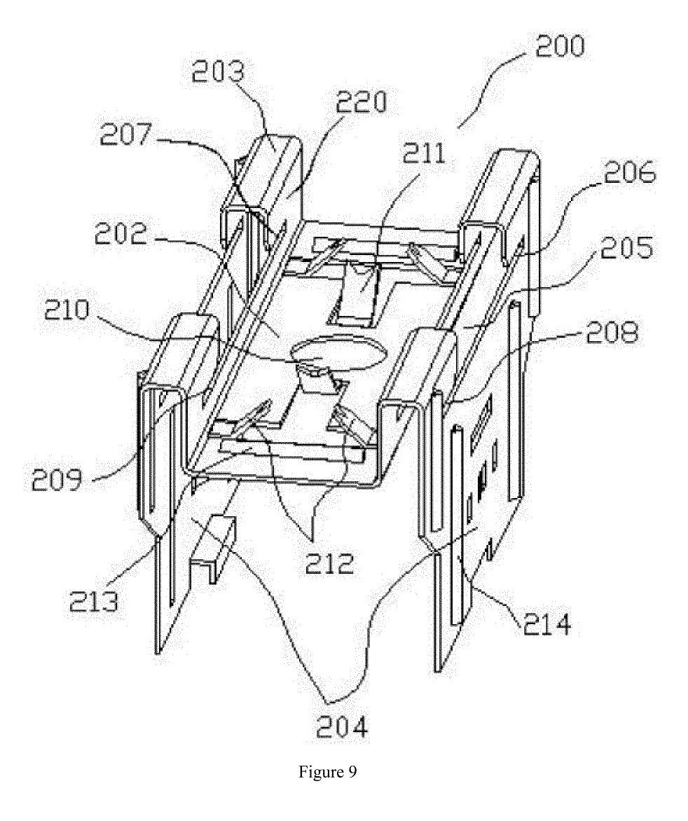

The first resilient protrusions 211 are preferably symmetrical to the center of the bottom plate. Alternatively, they can be symmetrically aligned to a virtual plane across the middle of the cut-outs in the inner and outer walls. The second resilient protrusions 212 can also be symmetrically aligned to the center of the plate or to the virtual plane. Although FIG. 4 exemplifies two pairs of symmetrically aligned first resilient protrusions 211, a single pair of first resilient protrusions 211 as shown in FIG. 9 can also be used depending on various factors as wind speed of the location. Likewise, the number of the second resilient protrusions 212 can vary according to cost and environmental considerations. In exemplary embodiments, the bottom plate 202 can have independently 0, 1, 2, 3, 4, 5, 6, 7, or 8 first and/or second resilient protrusions, which can be symmetrically or unsymmetrically disposed around the center of the bottom plate. In some embodiments, the protrusions can be formed from a cut-out from the bottom plate. In some embodiments, the structural components of the mounting bracket, including the bottom plate, the inner and outer walls and the top plate, are manufactured from a single piece of metal plate.

There can be various alternative embodiments to the first resilient protrusions 211 and the second resilient protrusion 212. For example, in some embodiments, the second resilient protrusions 212 can be closer to the entry point of the guiding channel than the first resilient protrusions 211 so that the L-shaped portion of the frame of the solar panel first engages 212 followed by 211. In further embodiments, the bottom plate can contain either the first resilient protrusions 211 or second resilient protrusions 212. In further embodiments, the first resilient protrusions 211 do not have to be each parallel to the inner walls. As long as they serve the purpose of preventing longitudinal movement of the solar panel along the guide channel, the orientation of the protrusion can vary. Likewise, the orientation of the second resilient protrusions does not have to be strictly parallel to the virtual plane across the middle of the cut-outs in the inner walls and outer walls if they provide resistance against lateral movement perpendicular to the guide channel.

While the first and second protrusions are in touch with a bottom surface of the frame of the solar panel, there can be one or more blocks or additional protrusions that are in contact with the vertical outside surface of the frame to prevent the frame from slipping out. For example, by moving a protrusion 211 towards the center of the bottom plate, it will lean against the outside vertical surface of the solar panel frame and keep it in the guiding channel. Of course, the angle and height of the block or protrusion can be adjusted.

The ratio between the length and width of the bottom plate 202 may vary depending on factors such as the configurations of the mounting bracket and the quantity of the first protrusions and/or second protrusions. In some exemplary embodiments, the ratio between the length and width of the bottom plate ranges from about 1:1 to about 10:1, from about 2:1 to about 5:1, or from about 3:2 to about 4:1. By selecting a suitable ratio, the stability and reliability of the mounting bracket can be enhanced.

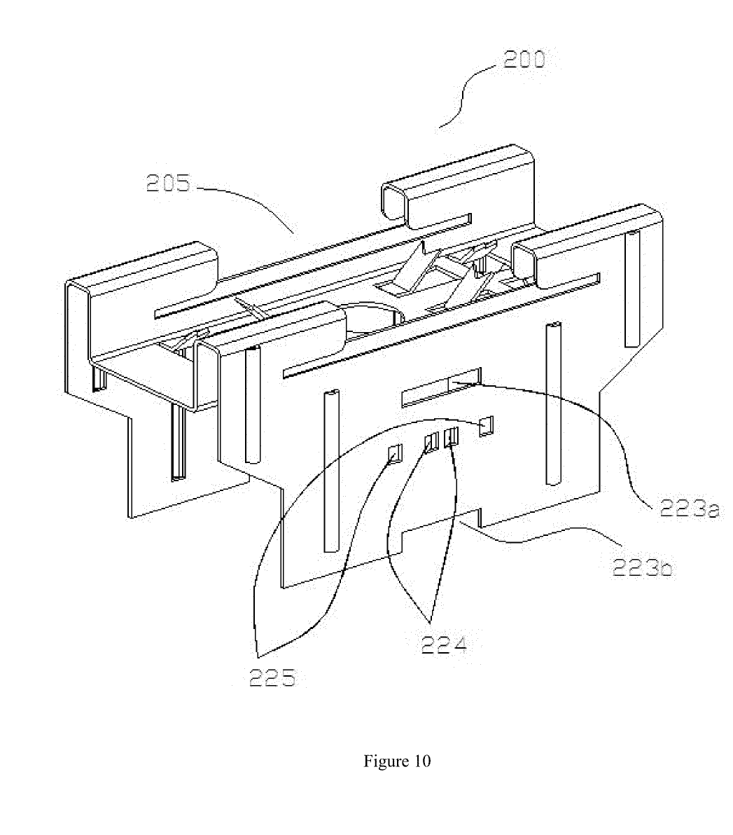

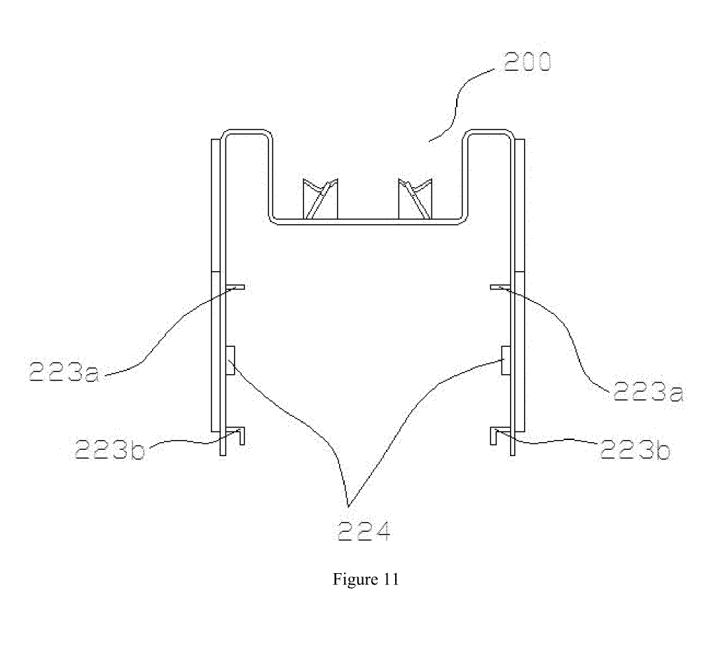

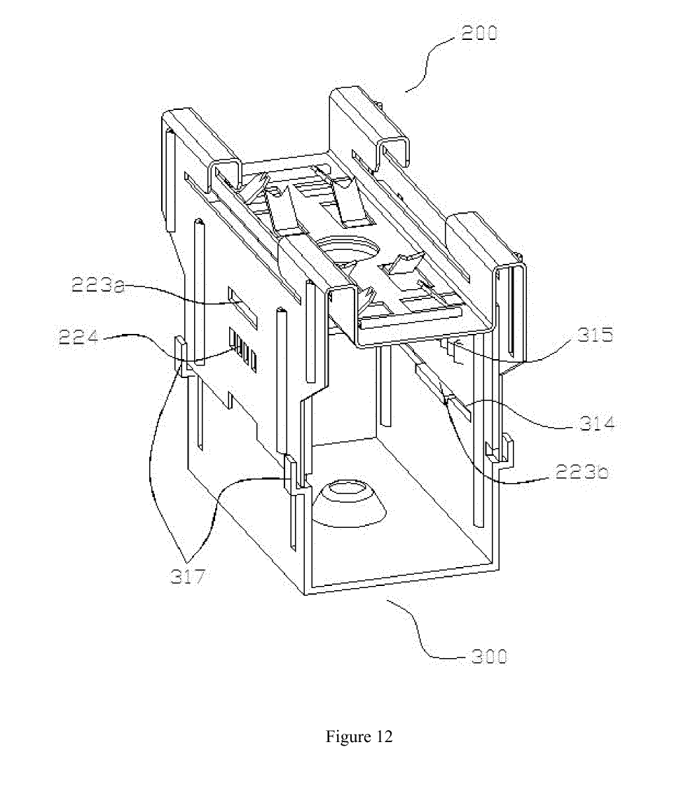

The bottom portion of the mounting bracket 200 serves to immobilize the bracket and secure it to a rooftop. For example, the mounting bracket 200 also include an adjustment means which engages the bracket with mounting base 300 and allows for spatial adjustment before fixing the bracket 200 to a suitable position. As illustrated in FIGS. 10 and 11, the mounting bracket 200 includes supporting arms 223 extending perpendicularly from the side plate. When the mounting bracket 200 engages initially with the mounting base 300 as illustrated in FIG. 12, the supporting arms 223(a) and 223(b) dock into the adjustment channel 314 which allows the bracket 200 to slide along the channel. It is to be noted that one or more of the supporting arms can have a L-shape as in 223(b) to reinforce the attachment of the mounting bracket to the mounting base. The L-shaped arms can be positioned below or above the straight arms 223(a).

A desired position can be secured by subsequently engaging the teeth 224 with the locking hole 315 on the mounting base. Meanwhile, the locking hole 225 can engage with teeth on the mounting base to reinforce the attachment of the mounting bracket 200 to the mounting based 300.

The locking means can include any combination of teeth and locking holes. For example, the side plate of the bracket may include one or both of the teeth and the locking holes. The mounting base can have one or both of the matching locking holes and the teeth to lock the mounting bracket in position.

Reinforcement bars 213 and 214 enhance the stability of the bracket and the durability of the overall assembly. However, the reinforcement bars can also be positioned at any portion of the bracket and in any orientation suitable. The shape of the reinforcement component is certainly not limited to bars and can include shapes such as cross and circles.

The optional aperture 210 on the bottom plate provides an access window to the mounting base, which can be secured to the anchor plate 100 with a screw. The shape, size and location of the aperture can certainly vary depending on the specific design and purpose of the aperture.

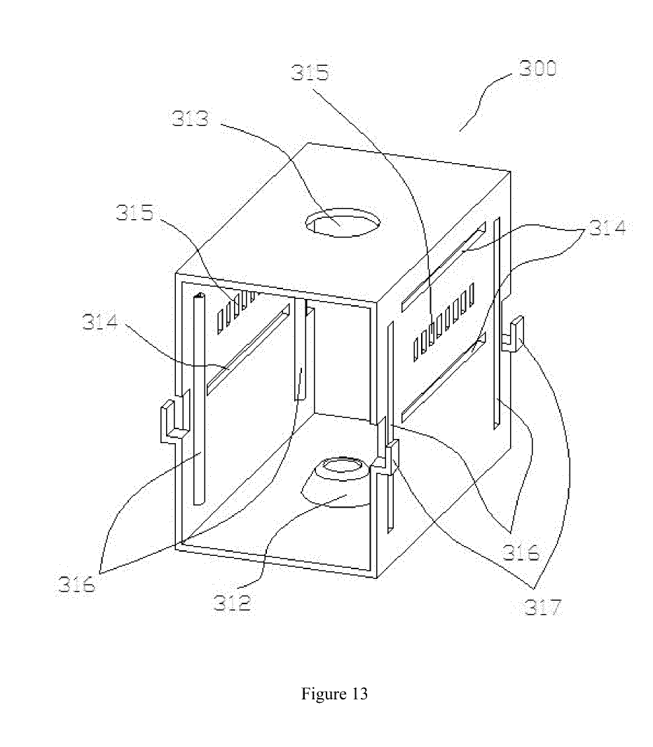

Referring to FIGS. 12 and 13, an exemplary embodiment of the mounting base 300 includes a box having a top, a bottom, a first and second side wall each disposed between the top and the bottom. The mounting base is installable on a roof top and movably attachable to the mounting bracket. The first and second side walls has an adjustment means located thereon and configured to engage with the supporting arm 223 of the mounting bracket and adjust position of the mounting bracket relative to the mounting base when the mounting bracket is placed on the mounting base. The adjustment means in FIG. 13 includes an adjustment channel 314 located on the side wall for receiving a supporting arm 223 so that the mounting bracket is slidable along the adjustment channel once the mounting bracket is placed on the mounting base, wherein the adjustment channel is parallel to the top of the box. The number and location of the adjustment channel can be the same or different on each of the side walls. The length of an adjustment channel may also be the same or different from other channels.

While the adjustment channel 314 is shown to be parallel to the top of the box, it can also be aligned with an angle relative to the top. When the mounting base and the bracket are to be installed on a rooftop with a slope, such an angle will offset the slope to place the adjustment channel horizontally. As a result, the weight of the supporting arm 223 of the mounting bracket 200 will be evenly placed on the adjustment channel rather 314 than at a lower end of the channel. Certainly, such a modified adjustment channel also requires a same angle for the supporting arm 223 relative to the bottom plate 202.

The adjustment means can further include an array of locking holes 315 on the first and second side walls of the mounting base, wherein the array of locking holes 315 are aligned parallel to the top of the box and are configured to engage with one or more teeth on a side plate of the mounting bracket so that the mounting bracket can be locked at a desired position in the adjustment channel on the mounting base.

The adjustment means on the mounting base can further include one or more teeth or locking pins on at least one of the first and second side walls of the mounting base. The one or more teeth will engage with one or more locking holes on one or more of the side plates of the mounting bracket to lock the mounting bracket in a particular position along the adjustment channel on the mounting base.

The adjustment means can include one or both of the locking holes and locking pins to match the respective locking pins and locking holes on the mounting bracket. The number of pins or holes and their locations can be adjusted to improve the stability of the mounting bracket on the mounting base.

The mounting base 300 also includes optional supporting tabs 317 on the first and second side walls. The supporting tabs 317 protrude from the surface of the side wall to engage with a bottom edge of the mounting bracket to provide support for the mounting bracket when placed on the mounting base.

One or more reinforcement bars 316 can be installed on the side walls of the mounting base. The number, shape and location of the reinforcement bars can vary so long as they serve the purpose of providing enhanced stability and durability.

An installation screw secures the mounting base 300 to the anchor plate through a mounting hole 312. An aperture 313 on the top of the mounting base 300 provides an access to install or remove the screw. The aperture can also be in a different shape if it does not compromise the integrity and durability of the whole assembly. In some embodiments, the structural components of box of the mounting base, including the top, the bottom, and the side walls are made from a one-piece metal plate.

Some of the structural features of bracket 200 can be translated to other bracket embodiments which also include, for example, the cutout from the top plate into the wall, the guide channels, and the bottom portion for securing the bracket to a base or a rooftop. The mounting bracket including all the structural components can be prepared from a single metal piece.

Accordingly, a mounting bracket similar to bracket 200 can include general structures of a top plate and a pair of parallel walls, wherein the parallel walls extend perpendicular to the top plate and are connected to opposite edges of the top plate. A cutout extends from the top plate downward into the parallel walls, wherein the cutout has two opposing side edges and a bottom edge in each of the walls. The bottom edge of the cutout is parallel to the top plate and extends beyond both side edges of the cutout to form a first and second guide channels on each side edge. Each of the first and second guide channels is configured to engage a L-shaped portion of a frame of a solar panel. The entry point of the guiding channels can have a convex-shaped surface to facilitate engaging the L-shaped portion of the solar panel.

The bracket also has attachment means similar to those described for bracket 200. For example, the adjustment means can include at least a supporting arm extending from at least one of the walls perpendicularly so that the supporting arm will engage with an adjustment channel on a side of the mounting base and is slidable along the adjustment channel when the mounting bracket is placed on the mounting base, wherein the adjustment channel is parallel to top plate of the mounting bracket. The adjustment means can also include one or more teeth that engage with one or more of an array of apertures on a side of the mounting base. Additional adjustment means can be a locking means including a locking hole on at least one of the walls of the mounting bracket for receiving a locking pin therethrough to engage with a side of the mounting base so that the mounting bracket is locked into position.

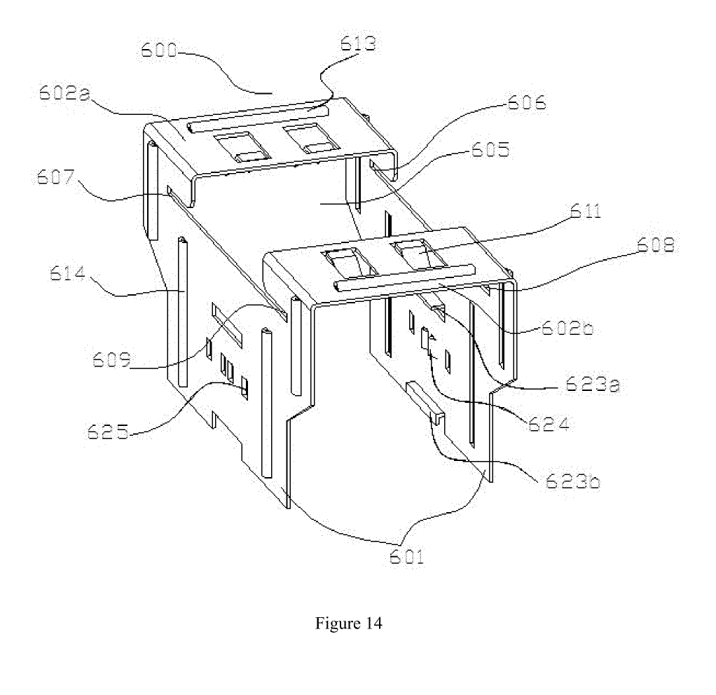

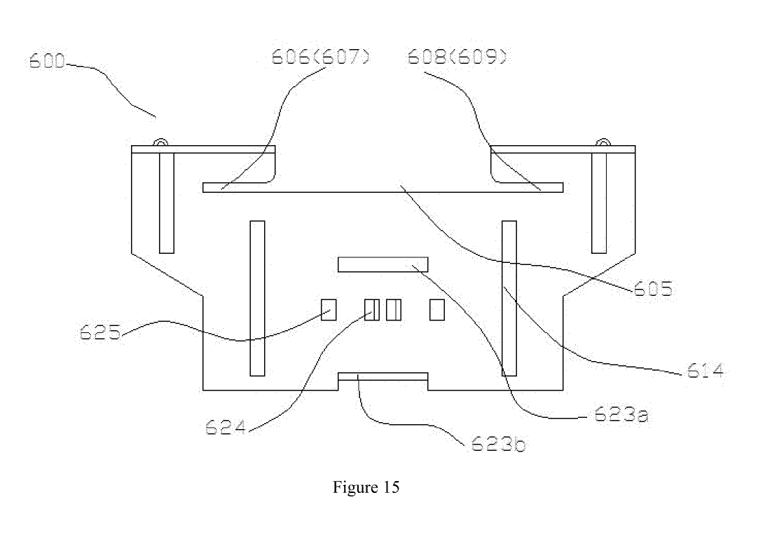

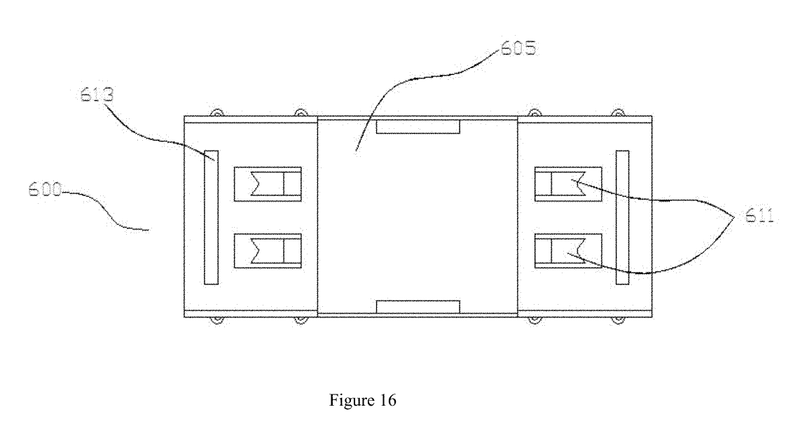

In a specific embodiment as exemplified in FIGS. 14-16, mounting bracket 600 includes a pair of parallel walls 601, a top plate 602 which includes a first portion 602a and a second portion 602b, a cutout 605, first guide channels 606 and 607, second guide channels 608 and 609, first resilient protrusion 611, reinforcement bar 613, supporting arm 623, teeth 624, and locking hole 625. The first resilient protrusion 611 protrudes from the top plate downwards at an angle with respect to a bottom surface of the top plate. The protrusion is oriented parallel to the walls and points away from a virtual plane across the middle of the cut-outs in the parallel walls. The protrusion can be a cutout metal piece as shown in FIG. 14. Alternatively, the protrusion can be a metal piece extending from an open edge of the top plate and functions similarly as above described to hold the solar panel in place. Preferably, the first resilient protrusion has a serrated top edge configured to touch a top surface of the frame of the solar panel when the L-shaped portion of the frame of the solar panel is fully engaged with the first or second guide channel so that the solar panel is prevented from longitudinal movement along the guide channel. The entry point of the guiding channels can have a convex-shaped surface to facilitate engaging the L-shaped portion of the solar panel.

Although the figures only depict the first resilient protrusion 611, the bracket 600 can optionally have a second resilient protrusion protruding from the top plate downwards at an angle with respect to the bottom surface of the top plate and oriented parallel to the virtual plane across the middle of the cut-outs in the parallel walls. The second resilient protrusion preferably has a serrated top edge configured to touch a top surface of the frame of the solar panel when the L-shaped portion of the frame of the solar panel is fully engaged with the first or second guide channel so that the solar panel is prevented from lateral movement perpendicular to the guide channel.

The mounting bracket 600 also has an adjustment means for engaging with a mounting base and adjusting position of the mounting bracket relative to the mounting base. The adjustment means, including supporting arm 623, teeth 624, and locking hole 625, is similar to those described for bracket 200 in FIG. 11. The adjustment means is generally positioned in the bottom portion of the walls.

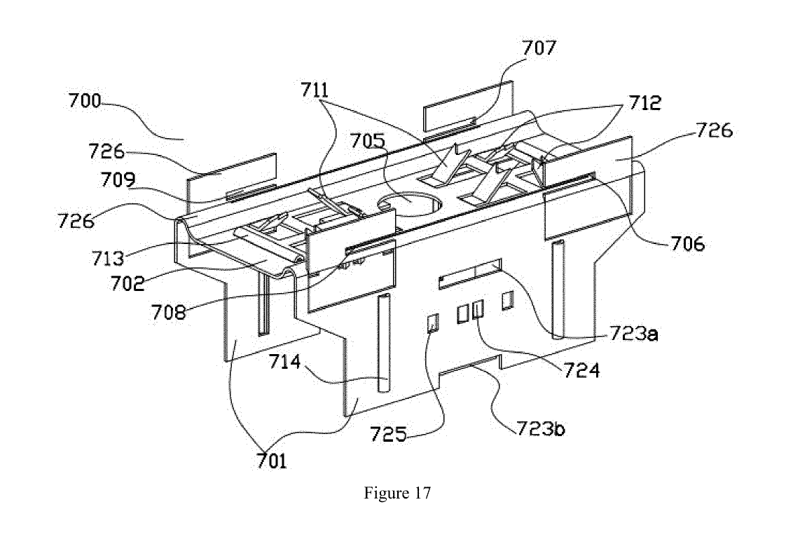

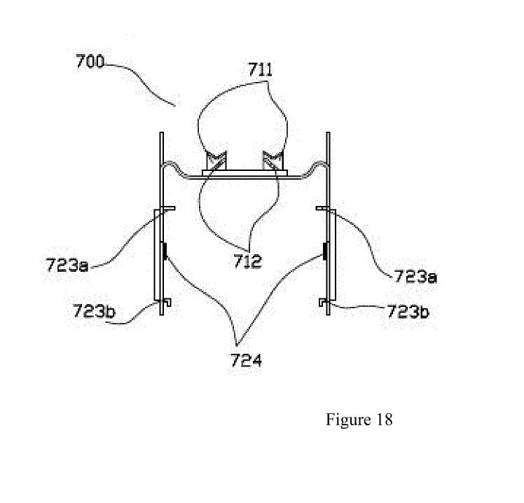

In another embodiment as exemplified in FIGS. 17-18, the mounting bracket 700 includes a pair walls 701, a top plate 702 perpendicularly disposed between the walls 701. A cutout 705 in the walls 701 includes first guide channels 706 and 707 and second guide channels 708 and 709. The edge portions of the top plate 702 can curve up to connect to the walls 701. The entry point of the guiding channels can have a convex-shaped surface to facilitate engaging the L-shaped portion of the solar panel. The walls 701 include top wing portions 726, which in some embodiments can be formed by flipping up a cutout portion of the wall. The first resilient protrusions 711, having a serrated top edge, point away at an angle from a virtual plane across the middle of the cutouts on in the walls. The second resilient protrusion 712 can similarly have a serrated top edge configured to touch a bottom surface of the frame of the solar panel. Supporting arm 723a has a L shape. The position and shape of supporting arm 723a and 723b are interchangeable. The top portion of the wall above the plate 702 is formed by flipping up a cut-out piece of wall body. The bracket can thus be prepared out of a single piece of material. Certainly, the top portion can also be manufactured by attaching separately a metal piece to the wall. Like other mounting brackets described herein, the main frame work of bracket 700, including the guide channels in the cutout portions, the walls, the top plate, and the protrusions can be manufactured from a single piece of metal.

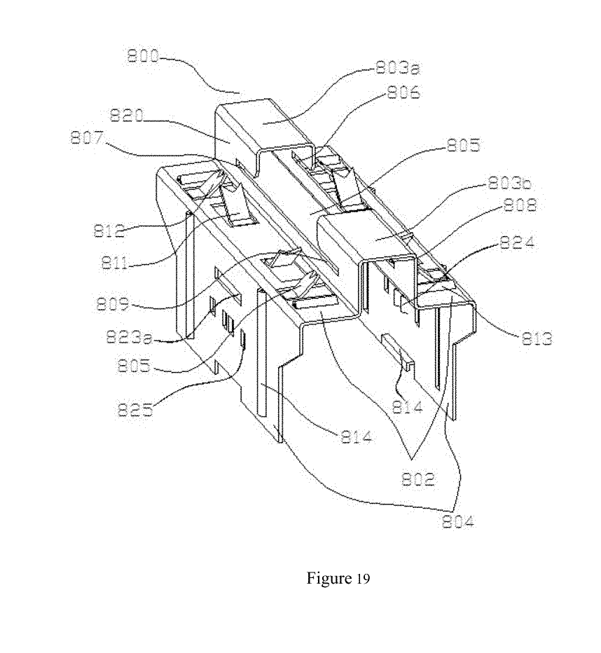

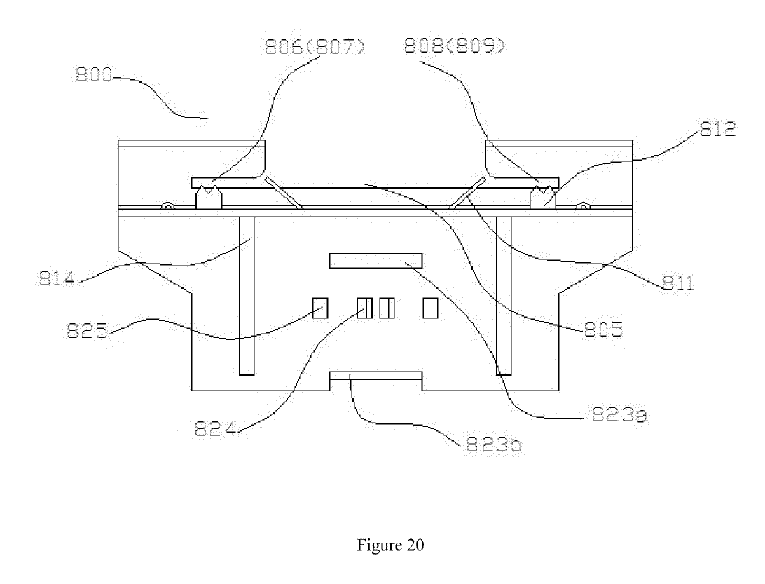

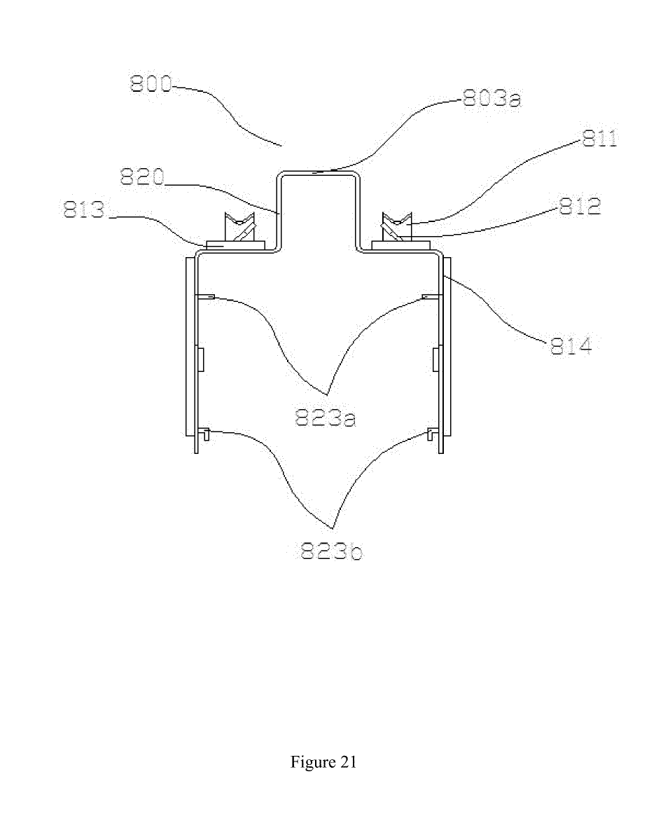

In another embodiment as exemplified in FIGS. 19-21, the mounting bracket 800 includes a pair of parallel top walls 820, a top plate 820 perpendicularly disposed between the top walls 820, a pair of bottom plates 802 perpendicularly connected to the respective bottom edges of the top walls, a pair of bottom walls 804 perpendicularly connected to the respective outer edges of the bottom plates 802. A cutout 805 in the top walls 820 includes first guide channels 806 and 807 and second guide channels 808 and 809. The cutout 805 also separates the top plate 803 into a first portion 803a and a second portion 803b. The entry point of the guiding channels can have a convex-shaped surface to facilitate engaging the L-shaped portion of the solar panel.

The first resilient protrusions 811 point away at an angle from a virtual plane across the middle of the cutouts on in the walls. As is illustrated in FIGS. 19-21, the first resilient protrusion 811 can have a serrated top edge configured to touch a bottom surface of the frame of the solar panel when the L-shaped portion of the frame of the solar panel is fully engaged with the first or second guide channel so that the solar panel is prevented from longitudinal movement along the guide channel. Similar to the first resilient protrusions 811, the second resilient protrusion 812 can similarly have a serrated top edge configured to touch a bottom surface of the frame of the solar panel. However, the second resilient protrusions 812 are oriented parallel to the virtual plane across the middle of the cut-outs on both sides of the mounting plate. Therefore, when the L-shaped portion of the frame of the solar panel is fully engaged with the first or second guide channel, the solar panel is prevented from lateral movement perpendicular to the guide channel.

As in bracket 200, the protrusions in bracket 800 may vary in terms of quantity, configuration, symmetry. The bottom walls 804 include attachments means as in the bottom portion of the outer walls 204 of bracket 200 (see FIG. 4 for comparison). As shown in FIGS. 19, the attachment means of bracket 800 includes one or more of supporting arm 823, teeth 824, and locking hole 825.

The first resilient protrusions 211 are preferably symmetrical to the center of the bottom plate. Alternatively, they can be symmetrically aligned to a virtual plane across the middle of the cut-outs in the inner and outer walls. The second resilient protrusions 212 can also be symmetrically aligned to the center of the plate or to the virtual plane. Although FIG. 4 exemplifies two pairs of symmetrically aligned first resilient protrusions 211, a single pair of first resilient protrusions 211 as shown in FIG. 9 can also be used depending on various factors as wind speed of the location. Likewise, the number of the second resilient protrusions 212 can vary according to cost and environmental considerations. In exemplary embodiments, the bottom plate 202 can have independently 0, 1, 2, 3, 4, 5, 6, 7, or 8 first and/or second resilient protrusions, which can be symmetrically or unsymmetrically disposed around the center of the bottom plate. In some embodiments, the protrusions can be formed from a cut-out from the bottom plate. In some embodiments, the structural components of the mounting bracket, including the bottom plate, the inner and outer walls and the top plate, are manufactured from a single piece of metal plate.

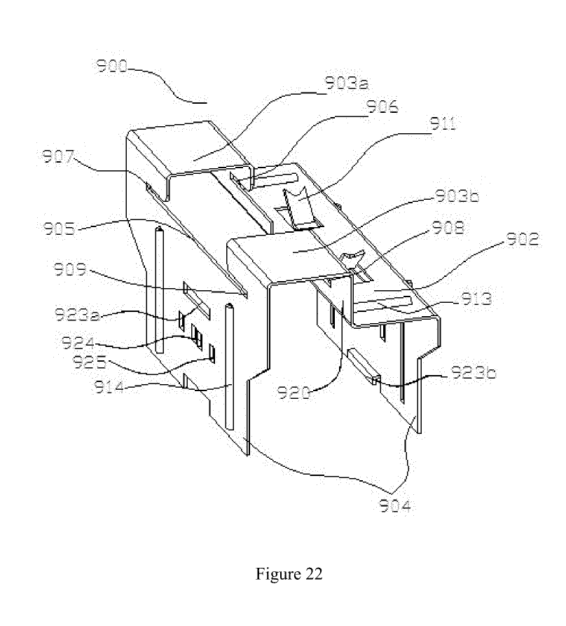

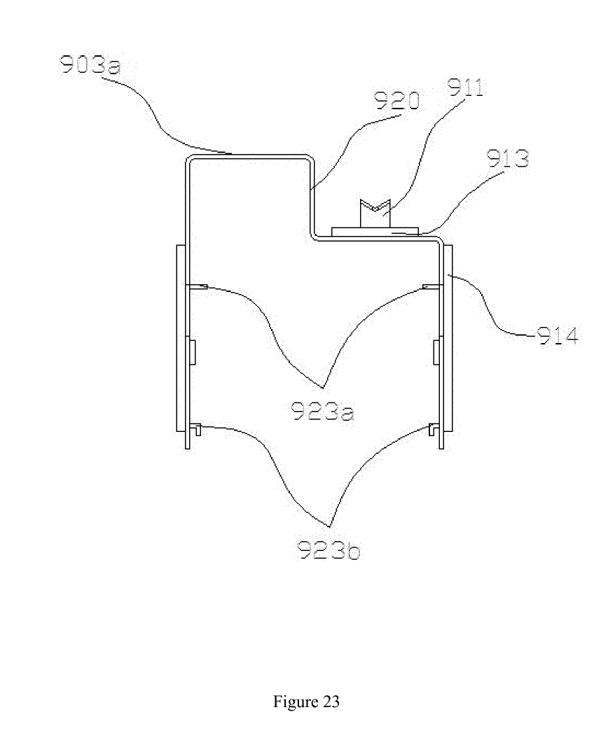

In a further embodiment relating to bracket 800 as shown in FIGS. 22 and 23, the mounting bracket 900 has one of the top walls 820 extends beyond the bottom surface of the bottom plate 802. The extended wall includes a cutout 805, guide channels, supporting arm 823, teeth 824 and locking hole 825 but without a flanking bottom plate. The other top wall, however, is perpendicularly connected to the bottom plate 802, which further connects to a bottom wall 804. The bottom wall 802 similarly includes attachments as the extend wall. Therefore, only one bottom plate 902 is present in bracket 900. The bottom plate 902 bears first protrusions 911 and second protrusions 912. The entry point of the guiding channels can have a convex-shaped surface to facilitate engaging the L-shaped portion of the solar panel.

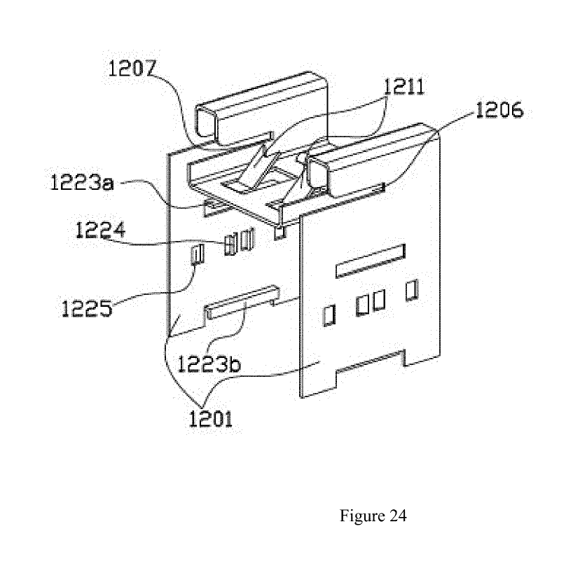

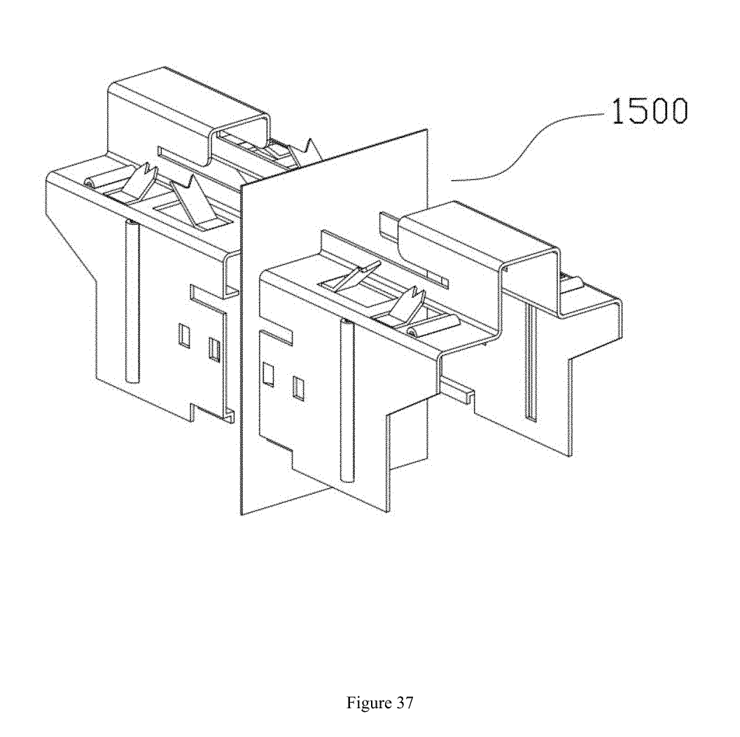

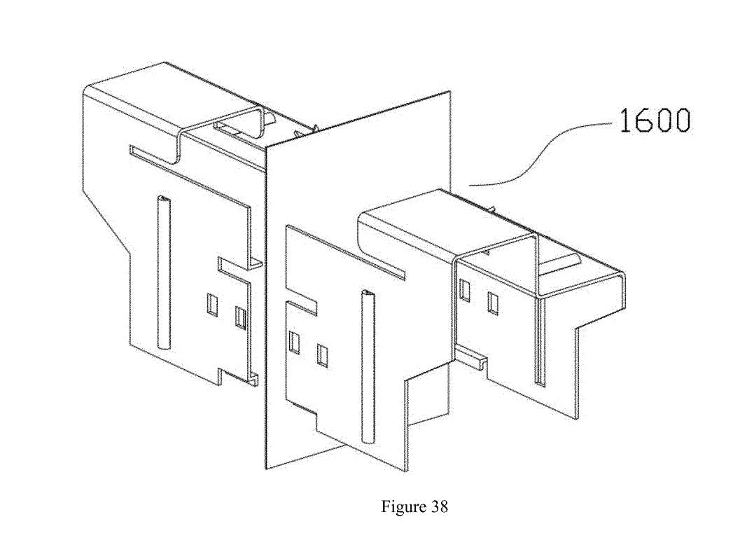

Each of the brackets described herein, including bracket 200, 600, 700, 800, and 900 with two sets of guiding channels, can also be modified to become two independent brackets as illustrated in FIGS. 24 and 35-38. For example, as shown in FIG. 24, bracket 1200 is derived from a half of bracket 200. Bracket 1200 includes guide channel 1206 and 1207, resilient protrusion 1211, supporting arm 1223a and 1223b, and adjustment means teeth 1224 and locking hole 1225. The resulting bracket offers more flexibility in securing the solar panel. For example, a bracket 1200 can be independently secured to the mounting base at any suitable position along the adjustment channel. In addition, a solar panel secured by bracket 1200 can be easily installed, reinstalled, or removed without moving or impacting adjacent solar panels. In similar fashion, a half section with a single set of guiding channels of bracket 600, 700, 800, and 900 can be manufactured and function to secure the solar panel.

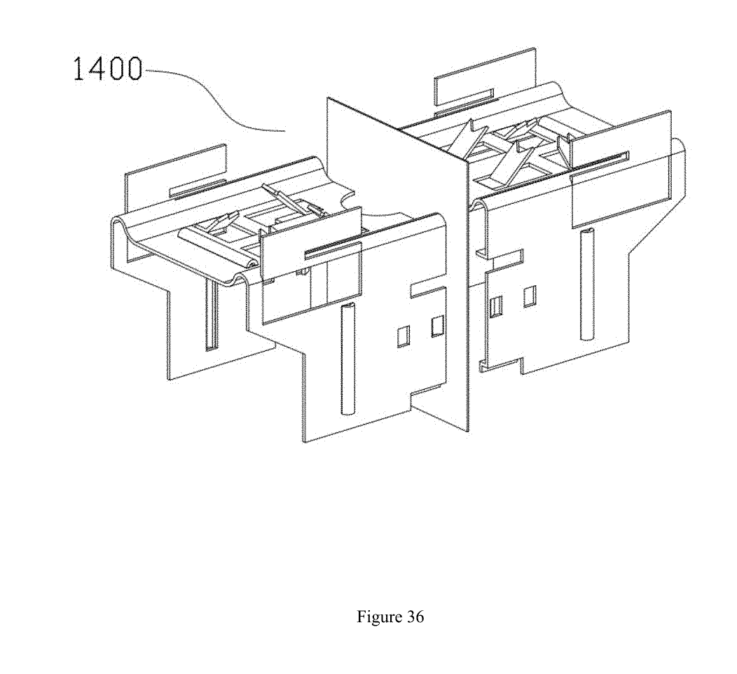

In a further example embodiment of FIG. 36, a full mounting bracket 700 can be cut in halves to provide two mounting brackets 1400.

Further, while the brackets in the figures generally include parallel walls, any portion of the walls can be in any form. For example, the walls of the bracket 600 can have an indented portion below or above the guiding channels in one or both of the walls.

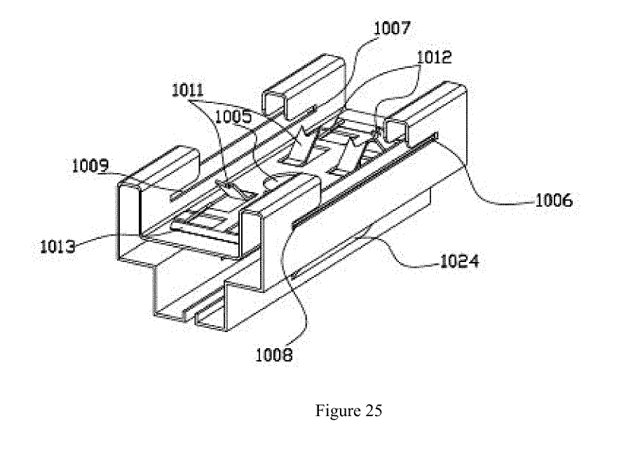

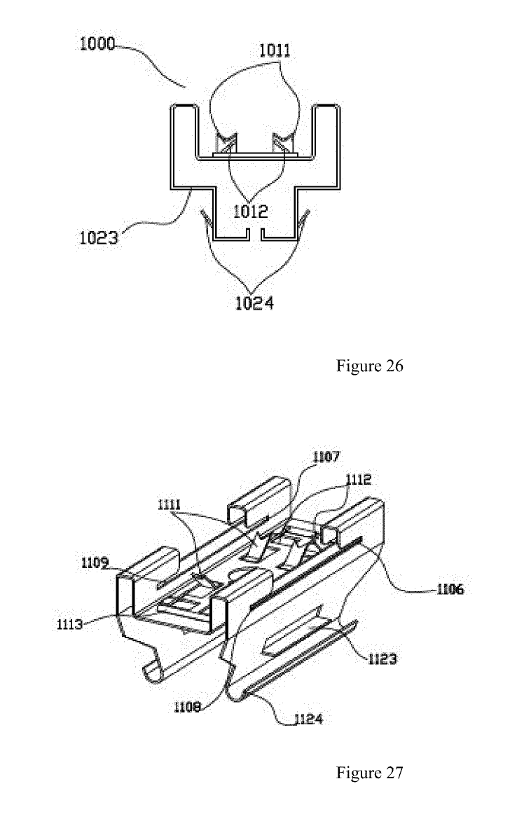

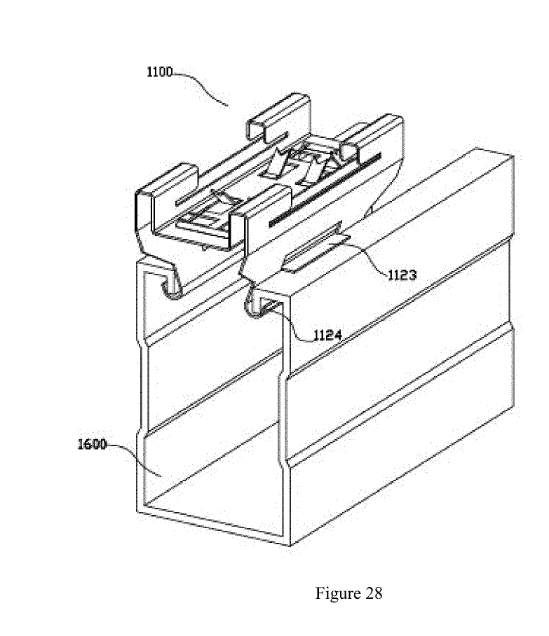

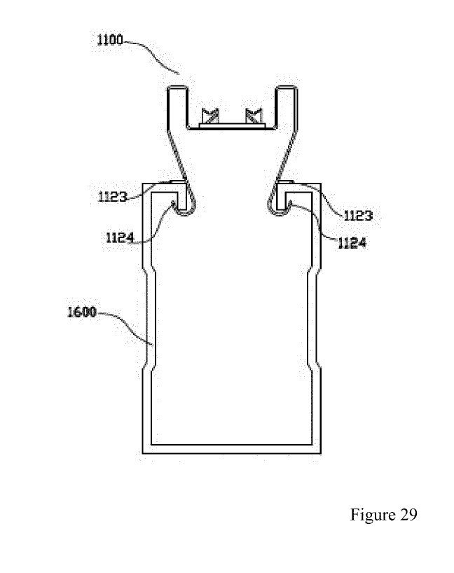

Different adjustment means can be incorporated into the mounting brackets. As shown in FIGS. 25-26, the wall 1023 of bracket 1000 in combination with an outward extending arm 1024 can secure the bracket to the mounting base. As shown in FIGS. 27-29, the bracket 1100 can be attached to the mounting base via an outward extending arm 1123 and a U-shaped channel 1124. The configuration of the mounting base can be adjusted accordingly to fit the bracket.

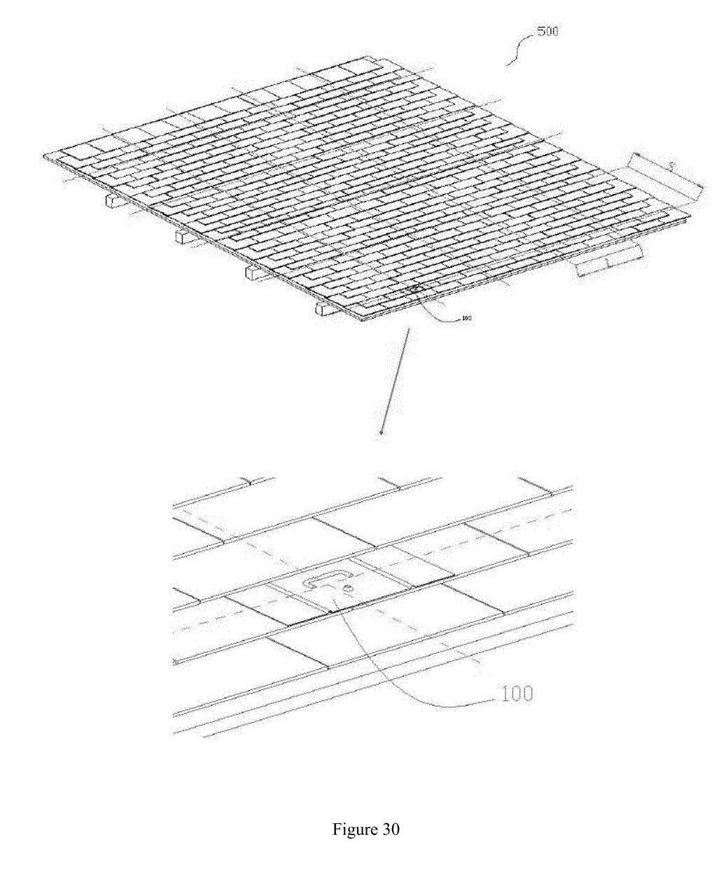

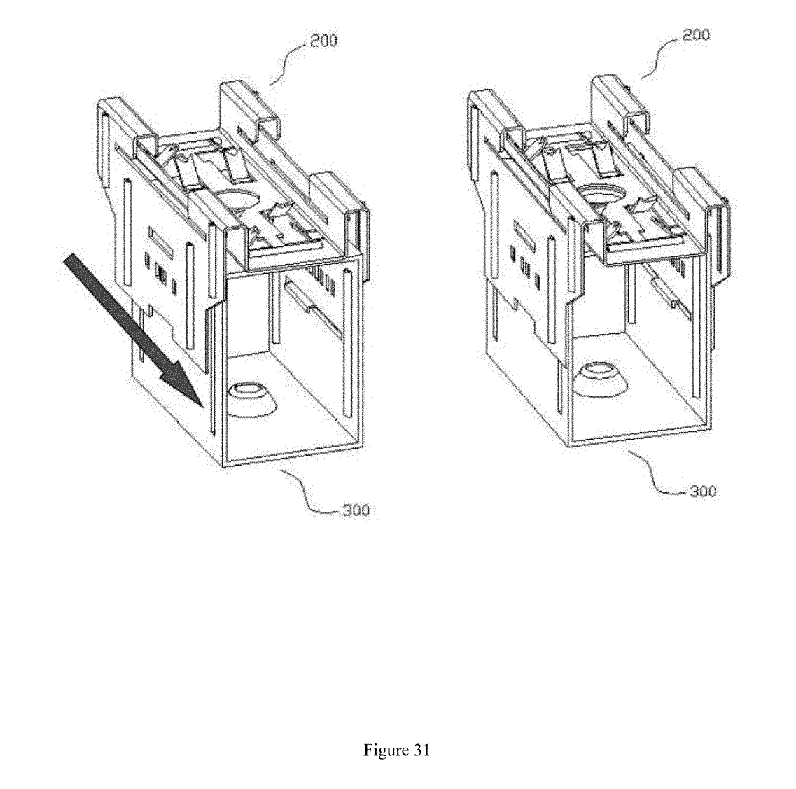

Another aspect of the invention provides a method of installing one or more solar panels on a structure or a roof top. As illustrated in an exemplary embodiment using bracket 200 in FIG. 30, the distance between each row of mounting apparatus is represented by S, which is defined by the sum of the width of a solar panel and the gap between solar panels. The distance between each column of mounting apparatus is represented by L, which is defined by the sum of the length of a solar panel and half of the gap between solar panels. The mounting base 300 is secured to the anchor panel 100 at the anchor point.

Generally, after the mounting bases 300 are installed, the mounting brackets 200 are place on a top surface of the mounting bases 300. One or more supporting arms 223 of the mounting bracket 200 are engaged with one or more adjustment channels 314 on the mounting base 300. The mounting brackets 200 are slidable along the adjustment channel. The components of the mounting brackets 200 and the mounting bases 300, including supporting arms, guide channels, and locking means are as described above.

Next, by sliding the supporting arm 223 of the mounting bracket 200 in a top or higher row further along the guide channel 314 on the mounting base 300, the mounting bracket 200 is fully engaged with the mounting base 300 as shown in FIG. 31. The locking means such as teeth 224 and locking holes 225 interact with the counterpart components on the mounting base 300 to further strengthen the attachment of the mounting bracket 200 to the mounting base 300.

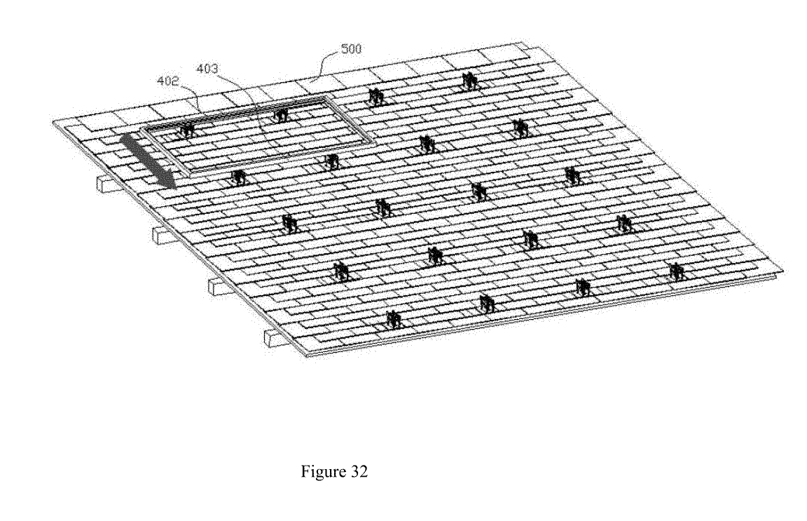

Next, a front bottom frame 402 of the solar panel 400 is then placed into the cutout of the mounting bracket in first row so that the L-shaped arm 401 of the front bottom frame 402 is aligned with the first guide channel as shown in FIG. 32. A rear bottom frame 403 of the solar panel is also placed into the cutout of the mounting bracket in a second row. The L-shaped arm 401 of the rear bottom frame 402 is aligned with the second guide channel of the mounting bracket in the second row. The first row can be a top or higher row and the second row can be an adjacent lower row.

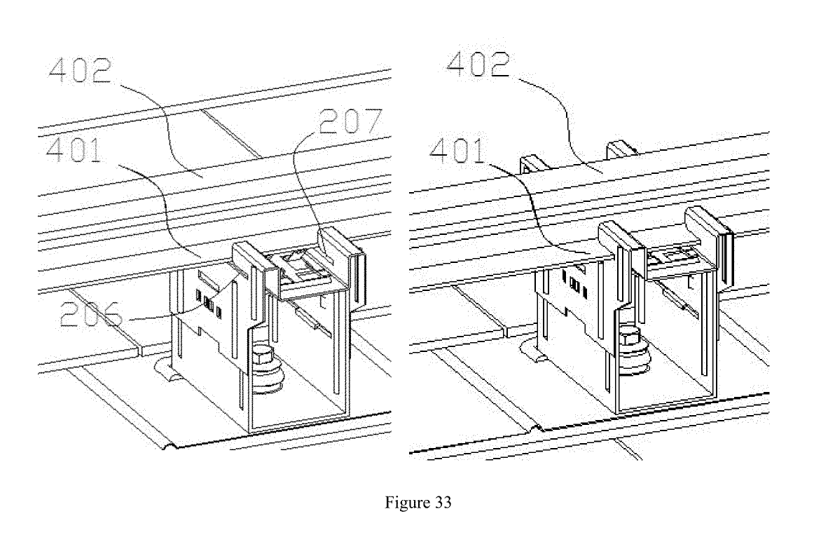

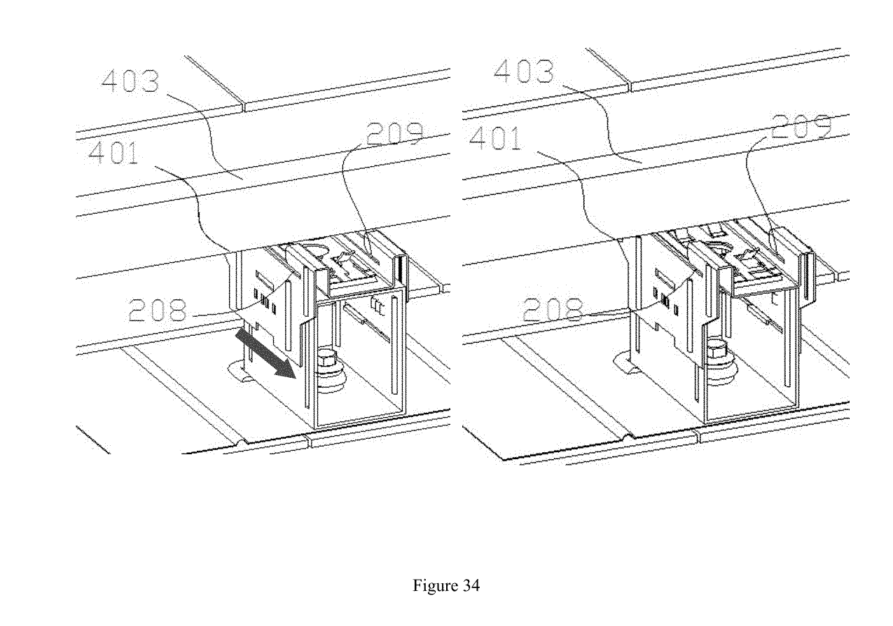

Next, the front bottom frame 402 of the solar panel 400 is slid downward as shown in FIG. 33. As a result, the L-shaped arm 401 of the front bottom frame 402 fully engages with the first guide channel 206 and 207 of the mounting bracket in the first row. If there are two or more mounting brackets in contact with the front bottom frame 402, sliding the frame enables the L-shaped arm 401 to fully engage with the first guide channels of those mounting brackets.

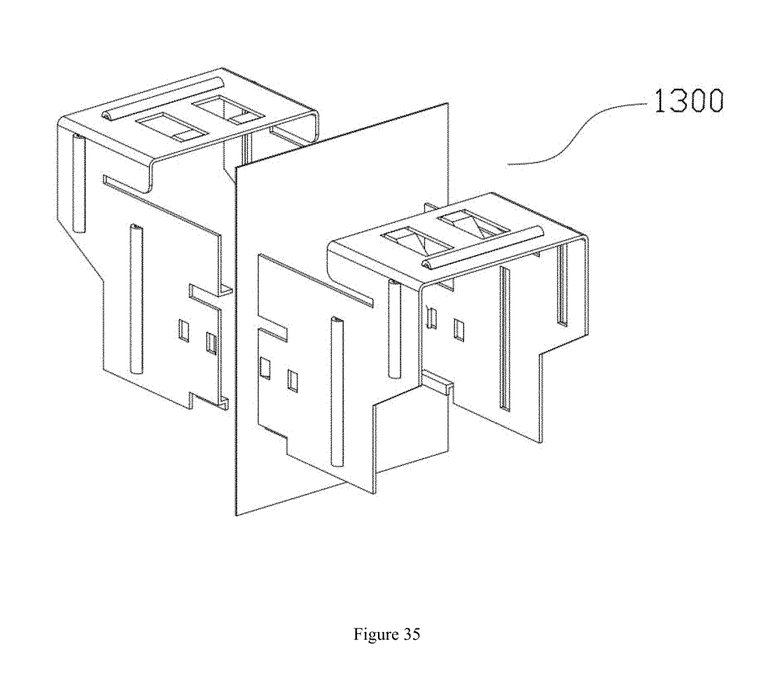

Next, the mounting bracket in the second row is slid downward as shown in FIG. 34. Therefore, the L-shaped arm 401 of the rear bottom frame 402 fully engages with the second guide channel 208 and 209 of the mounting bracket in the second row. The L-shaped arm can fully engage with two or more second guide channels by sliding the respective mounting brackets in the same row. The mounting bracket in the second row is then secured to the respective mounting base via a locking means as described above.

1. A mounting bracket comprising a top plate and a first pair of top walls, wherein the top walls are connected to opposite edges of the top plate, further wherein a cutout extends from a top edge of each of the walls, the cutout having two opposing side edges and a bottom edge in each of the walls, further wherein the bottom edge of the cutout extends beyond both side edges of the cutout to form a first and second guide channels on each side edge, and each of the first and second guide channels is configured to engage a L-shaped portion of a frame of a solar panel.

2. The mounting bracket of claim 1, wherein at least one of the walls of the mounting bracket has an adjustment means for engaging with a mounting base and adjusting position of the mounting bracket relative to the mounting base.

3. The mounting bracket of claim 2, wherein the adjustment means comprises at least a supporting arm extending from at least one of the walls and is configured for engaging an adjustment channel on the mounting base and is slidable along the adjustment channel when the mounting bracket is placed on the mounting base, wherein the adjustment channel is parallel to top plate of the mounting bracket.

4. The mounting bracket of claim 3, wherein the adjustment means further comprises one or more teeth that engage with one or more of an array of apertures on the mounting base.

5. The mounting bracket of claim 3, wherein the adjustment means further comprises a locking means comprising a locking hole on at least one of the walls of the mounting bracket for receiving a locking pin therethrough to engage with a side of the mounting base so that the mounting bracket is locked into position.

6. The mounting bracket of claim 1, wherein an entry point of the guiding channels has a convex-shaped surface to facilitate engaging the L-shaped portion of the solar panel.

7. The mounting bracket of claim 1, wherein the top plate comprises an attachment means for securing the solar panel onto the mounting bracket once the L-shaped portion of the frame of the solar panel is fully engaged with the first or second guide channel, wherein the attachment means comprises:
at least a first resilient protrusion protruding from the top plate downwards at an angle with respect to a bottom surface of the top plate, wherein the protrusion is oriented parallel to the walls and points away from a virtual plane across the middle of the cut-outs in the parallel walls.

8. The mounting bracket of claim 7, wherein the first resilient protrusion has a serrated top edge configured to touch a top surface of the frame of the solar panel when the L-shaped portion of the frame of the solar panel is fully engaged with the first or second guide channel so that the solar panel is prevented from longitudinal movement along the guide channel.

9. The mounting bracket of claim 7, wherein the attachment means further comprises:
at least a second resilient protrusion protruding from the top plate downwards at an angle with respect to the bottom surface of the top plate and oriented parallel to the virtual plane across the middle of the cut-outs in the parallel walls, wherein the second resilient protrusion has a serrated top edge configured to touch a top surface of the frame of the solar panel when the L-shaped portion of the frame of the solar panel is fully engaged with the first or second guide channel so that the solar panel is prevented from lateral movement perpendicular to the guide channel.

10. The mounting bracket of claim 1, wherein one of the top walls is perpendicularly connected to a bottom plate, the bottom plate extending outward and further connecting perpendicularly to a lower wall.

11. The mounting bracket of claim 10, wherein bottom plate comprises an attachment means for securing the solar panel onto the mounting bracket once the L-shaped portion of the frame of the solar panel is fully engaged with the first or second guide channel, wherein the attachment means comprises:
at least a first resilient protrusion protruding from the bottom plate upwards at an angle with respect to a top surface of the bottom plate, wherein the protrusion is oriented parallel to the inner side plate and pointing away from a virtual plane across the middle of the cut-outs in the walls.

12. The mounting bracket of claim 1, wherein each of the top walls is perpendicularly connected to a respective bottom plate, the bottom plate extending outward from the bottom edge of the respective wall and further connecting to a respective bottom wall, wherein the bottom wall extends below a bottom surface of the respective bottom plate.

13. The mounting bracket of claim 12, wherein at least one of the bottom plates comprises an attachment means for securing the solar panel onto the mounting bracket once the L-shaped portion of the frame of the solar panel is fully engaged with the first or second guide channel, wherein the attachment means comprises:
at least a first resilient protrusion protruding from the bottom plate upwards at an angle with respect to a top surface of the bottom plate, wherein the protrusion is oriented parallel to the inner side plate and pointing away from a virtual plane across the middle of the cut-outs in the walls.

14. The mounting bracket of claim 13, wherein the first resilient protrusion has a serrated top edge configured to touch a top surface of the frame of the solar panel when the L-shaped portion of the frame of the solar panel is fully engaged with the first or second guide channel so that the solar panel is prevented from longitudinal movement along the guide channel.

15. The mounting bracket of claim 13, wherein the attachment means further comprises:
at least a second resilient protrusion protruding from the bottom plate upwards at an angle with respect to the surface of the mounting plate and oriented parallel to the virtual plane across the middle of the cut-outs on both sides of the mounting plate, wherein the second resilient protrusion has a serrated top edge configured to touch a bottom surface of the frame of the solar panel when the L-shaped portion of the frame of the solar panel is fully engaged with the first or second guide channel so that the solar panel is prevented from lateral movement perpendicular to the guide channel.

16. The mounting bracket of claim 1, wherein the top edge of each of the top walls is above a top surface of the top plate.

17. The mounting bracket of claim 16, wherein the top plate comprises at least a first resilient protrusion protruding from the top plate upwards at an angle, wherein the protrusion points away from a virtual plane across the middle of the cut-outs in the parallel walls.

18. The mounting bracket of claim 1, further comprising a second pair of top walls and a bottom plate perpendicularly disposed between the first pair and the second pair of top walls, and each of the second pair of walls defines a mirror cutout and mirror guide channels that substantially mirror the respective cutout and guide channels in the first pair of walls across a virtual plane in the middle of the bottom plate.

19. A mounting bracket comprising:
a first pair of parallel walls having a first inner wall and a first outer wall, the a first inner wall and the first outer wall at their respective top edges connected to opposite edges of a first top plate disposed between the first pair of walls,
a second pair of parallel walls having a second inner wall and a second outer wall, the second inner wall and the second outer wall at their respective top edges connected to opposite edges of a second top plate disposed between the second pair of walls, a bottom plate perpendicularly disposed between the first and second inner walls and connected to the respective bottom edges of the first and second inner walls,
wherein the inner and outer walls each comprise a cutout from the respective top plates for receiving a frame of one or more solar panels, the cutout having two opposing side edges and a bottom edge above the bottom plate, further wherein the bottom edge of the cutout is parallel to the bottom plate and extends beyond both side edges of the cutout to form a first and second guide channels on each side edge, each of the first and second guide channels is configured to engage a L-shaped portion of a frame of a solar panel.

20. The mounting bracket of claim 19, further comprising an attachment means for securing the solar panel onto the mounting bracket once the L-shaped portion of the frame of the solar panel is fully engaged with the first or second guide channel, wherein the attachment means comprises:
at least a first resilient protrusion protruding from the bottom plate upwards at an angle with respect to a top surface of the bottom plate, wherein the protrusion is oriented parallel to the inner side plate and pointing away from a virtual plane across the middle of the cut-outs.

21. A mounting bracket for mounting a solar panel, comprising:
a pair of parallel inner walls perpendicularly connected to opposite edges of a top plate, wherein the inner walls each comprise a first guide channel extending from a side edge of the walls, further wherein the first guide channels are parallel to each other and are configured to engage a L-shaped portion of a frame of a solar panel.

22. The mounting bracket of claim 21, wherein the top plate is below a virtual plane across the parallel first guide channels.

23. The mounting bracket of claim 21, further comprising a pair of outer walls parallel to the inner walls, wherein each of the outer walls is connected to the respective inner wall via a top ridge, and each of the outer walls comprises a second guide channel extending from a side edge of the outer walls, the second guide channels in the same plane with the first guide channels.

24. The mounting bracket of claim 21, further comprising an attachment means for securing the solar panel onto the mounting bracket once the L-shaped portion of the frame of the solar panel is fully engaged with the guide channel, wherein the attachment means comprises: at least a first resilient protrusion protruding from the top plate upwards at an angle with respect to a top surface of the mounting plate, wherein the protrusion point away from a virtual plane across the opening of the first guide channels to prevent the solar panel from slipping out of the guide channels.

25. The mounting bracket of claim 21, further comprising a pair of outer walls, wherein each of the outer walls are connected to the respective inner wall via a bottom plate, and wherein the bottom plate comprises at least a first resilient protrusion protruding from the top plate upwards at an angle with respect to a top surface of the bottom plate, the protrusion pointing away from a virtual plane across the opening of the first guide channels to prevent the solar panel from slipping out of the guide channels.
